(19) United States
(12) Patent Application Publication
(10) Pub. No.: US 2005/0022118 A1
(43) Pub. Date: Jan. 27, 2005

(54) Methods and systems for creating book text structures

(76) Inventors: Marcus Wefers, Heidelberg (DE); Thomas Fleckenstein, Frankenthal (DE)

Correspondence Address: Finnegan, Henderson, Farabow,;Garrett & Dunner, L.L.P., 1300 I Street, N.W., Washington, DC, 20005-3315, US

(21) Appl. No.: 10/879,003

(22) Filed: Jun. 30, 2004

(30) Foreign Application Priority Data
Jun. 30, 2003 (EP) 03014824.1

(51) Int. Cl. G06F 7/00

(52) U.S. Cl. 715/513

(57) ABSTRACT

Methods and systems are disclosed for creating book text structures. Such methods and systems may be implemented for generating updated book versions. In one embodiment, the method may comprise creating, on a client front-end computer, a book text structure by generating layout templates, and receiving, on a database server unit containing a collection of logical units, a request from the client front-end computer for data to be allocated to the layout templates. The method may also include interpreting template structure data that is requested, selecting required data based on the logical units, assigning layout templates to book chapters, retrieving required data and inserting the retrieved data in a book chapter structure, and generating a markup language file on the basis of the chapter structure containing the retrieved data. Further, the method may include importing, on the client front-end computer, the generated markup language file and converting the same into a print format file.

### FIELD OF THE INVENTION

The present invention generally relates to the field of electronic data processing and, more particularly, the invention relates to the automated creation of book text structures.

### BACKGROUND OF THE INVENTION

There are many cases and situations in which book text structures are used for reporting and/or instructing purposes. Such book text structures could be so-called briefing books that are used in project or development teams in order to give updated reports on a project or development status to a team leader and/or other team members. A book text structure in the context of the present invention could also be an instruction manual for an industrial machine in a manufacturing line, a household appliance or the like. In all of these book text structures, there is a need of repeated updating when changes occur. In the context of a briefing book, there would be the necessity to generate an updated book version periodically for team meetings or report due dates. Further, in the context of instruction manuals, there could be a need for an updated version every time a new version of the machine or apparatus is sold or, in a manufacturing line, when new products are manufactured with an existing machine and new settings and parameters have to be considered.

Until now, an updated book version had to be prepared manually, i.e., the changes which occurred since the last edition of the book had to be gathered “manually” in electronic files or on paper and then inserted by a responsible person in a given layout for the book text structure.

The applicant of the present application provides a so-called balanced score card (BSC) application that is a comprehensive solution to support the strategy management process within an enterprise. The BSC-application allows the creation of so-called “score cards” which consist of “perspectives”, “strategies”, “objectives”, “measures”, “initiatives” and “risks”. For each of the mentioned elements, a large number of details exist, such as definitions, owners, status indicators, time series and many others. The BSC application is an online tool that allows standard reporting and printing functionality.

### SUMMARY OF THE INVENTION

In view of the foregoing, it is an object of the invention to provide methods and systems that allow for automated repeated generation of book text structures, such as updated versions of book text structures, without the involvement of human operators. Additionally, it is an object of the invention to provide methods and systems which allow for the creation of book text structures on the basis of information available from an existing database for further analysis based on specific information needs, taking into account the need to create a document repeatedly with the same structure but with updated information in given periods.

According to one embodiment, a computer-implemented method is provided for creating a book text structure for the generation of updated book versions. The method may comprise steps performed on a client front-end computer and/or steps performed on a database server unit. Consistent with this method, layout templates for various object types may be created on the client front-end computer. When a computer program consistent with embodiments of the invention is run on the front-end computer, a request for data to be allocated to the layout templates is sent from the client front-end computer to the database server unit, which comprises a collection of logical units. The database server unit receives this request and interprets the template structure data that is requested. Then, the database server unit selects data based on the logical units and assigns layout templates to book chapters. In a further step performed on the database server unit, the required data is retrieved and inserted in the chapter structure created before, and a markup language file is generated on the basis of the chapter structure containing the retrieved data. The markup language file is exported to the client front-end computer where it is converted into a print format file. Preferably, the markup language file may be submitted to a final editing before being converted into the print format file. Moreover, the markup language may be an extensible markup language, such as XML.

Embodiments of the invention are also directed to methods and systems that enable a user to repeatedly generate updated versions of a predetermined book text structure. Such systems and methods may retrieve the required data from an existing collection of selectable data via logical units. As disclosed herein, the logical units may assign the given layout templates to book chapters and retrieve the required data.

Further embodiments of the invention relate to computer programs with program code suitable for carrying out methods consistent with the features and principles of the invention, as disclosed herein. In addition to be part of a computer program, the program code may also be stored on a computer-readable medium.

Further features and embodiments of the invention will become apparent from the description and the accompanying drawings.

It will be understood that the features mentioned above and those described hereinafter can be used not only in the combination specified but also in other combinations or on their own, without departing from the scope of the present invention.

Embodiments of the invention are schematically illustrated in the drawings by way of examples and are hereinafter explained in detail with reference to the drawings. It is understood that the description is in no way limiting on the scope of the present invention and is merely an illustration of the embodiments of the invention.

### BRIEF DESCRIPTION OF THE DRAWINGS

In the drawings,

FIG. 1 is a schematic view of an exemplary book text structure creation computer system, consistent with the invention;

FIG. 2 is a schematic block diagram of an exemplary process for creating a briefing book, consistent with the invention;

FIG. 3 is a schematic block diagram visualizing in more detail how data is retrieved from a set of selectable data and an extensible markup language file is created in order to generate a briefing book, consistent with the invention;

FIG. 4 is a schematic block diagram of the set-up of an exemplary processing environment, consistent with the invention;

FIG. 5 is a screen shot illustrating an exemplary split screen embodiment for selection of logical units, consistent with the invention; and

FIG. 6 is an illustration of an exemplary structure behind the split screens of FIG. 5.

### DETAILED DESCRIPTION

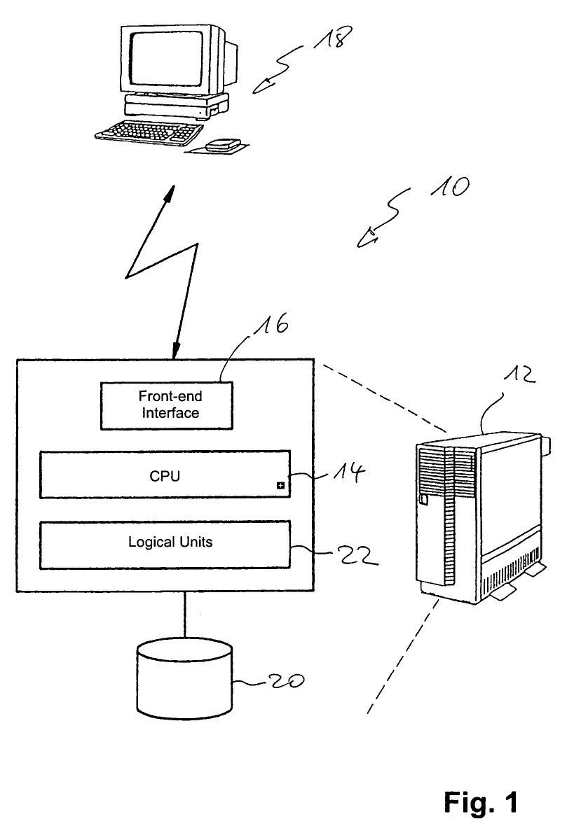

FIG. 1 shows an exemplary computer system 10 for creating a book text structure, consistent with the invention. The embodiment of FIG. 1 may be used for the repeated generation of updated book versions. As shown, computer system 10 may include a client front-end computer 18 and a database server unit 12. The database server unit 12 may comprise a front-end interface 16 for interconnection with the client front-end computer 18, a central processing unit (CPU) 14, a collection or repository of so-called logical units 22, and a database 20 with a collection of selectable data stored thereon. Consistent with the invention, CPU 14 may comprise a number of computing modules and/or tools for performing a computer-implemented method for creating a book text structure. Such a method may provide for repeated generation of updated book versions according to the features and principles of the invention, as disclosed herein.

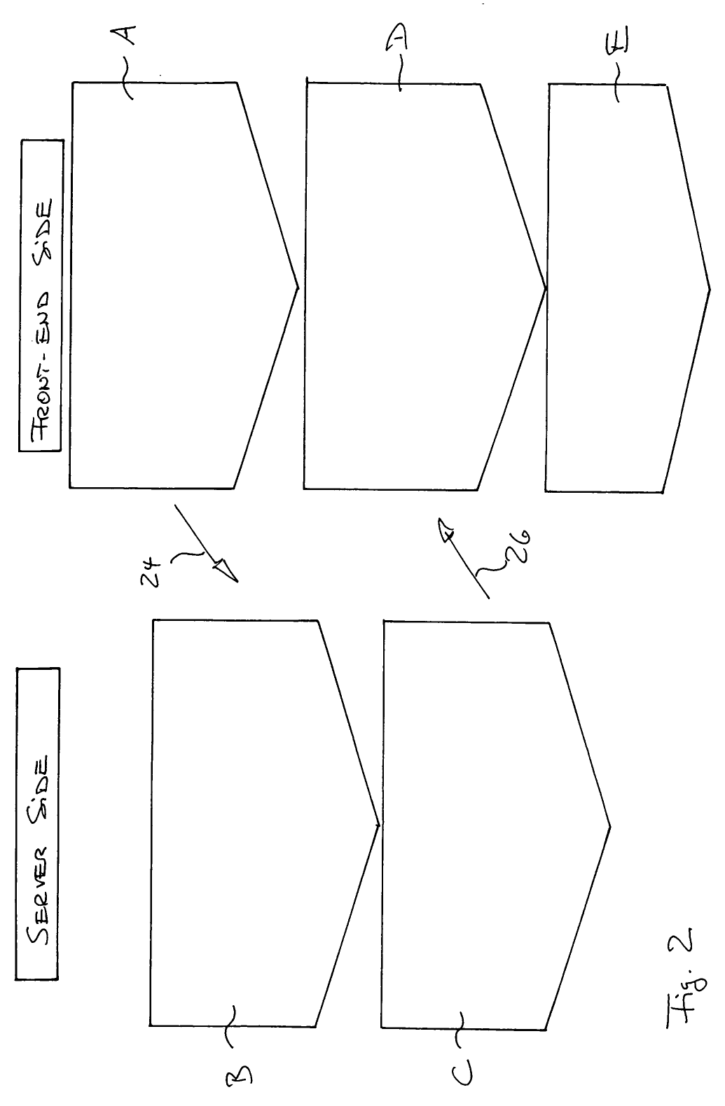

Referring now to FIG. 2, a flow chart of an exemplary method is provided, consistent with the invention. The exemplary method of FIG. 2 may be computer-implemented and used for creating book text structures, such as for the generation of updated book versions. By way of example, the exemplary method of FIG. 2 may be performed on client front-end computer 18 (designated as “front-end side” in FIG. 2), on the one hand, and on database server unit 12 (designated as “server side” in FIG. 2) on the other hand.

In step A, a user creates layout templates (i.e., format definitions) for various object types on the client front-end computer 18 (i.e., types of objects or data used on the client front-end computer). This can consist of taking over existing formats or changing existing formats or even create new formats. In one embodiment, step A is preferably performed utilizing commercially available software applications, such as Adobe Frame Maker or Adobe InDesign or the like. In step A, the user may create a book text structure for the book to be generated, containing information on: which “chapters” the book will have, which data should be represented in it, and which layout template should be used to format it. In the embodiment described hereinafter, the book to be generated is a so-called briefing book, which could be described as a report book for periodically briefing a team leader and/or team members on the status of the team's project development. However, as will be appreciated by those skilled in the art, embodiments of the invention can also be applied in other areas where updated versions of descriptions, reports and the like have to be generated periodically. For instance, one preferred area of application is in manufacturing or in research.

When the user wants a briefing book to be generated, the user sends a request from front-end computer 18 to the database server unit 12 (arrow 24 in FIG. 2). Such a request may be sent on the basis of the layout templates created in step A.

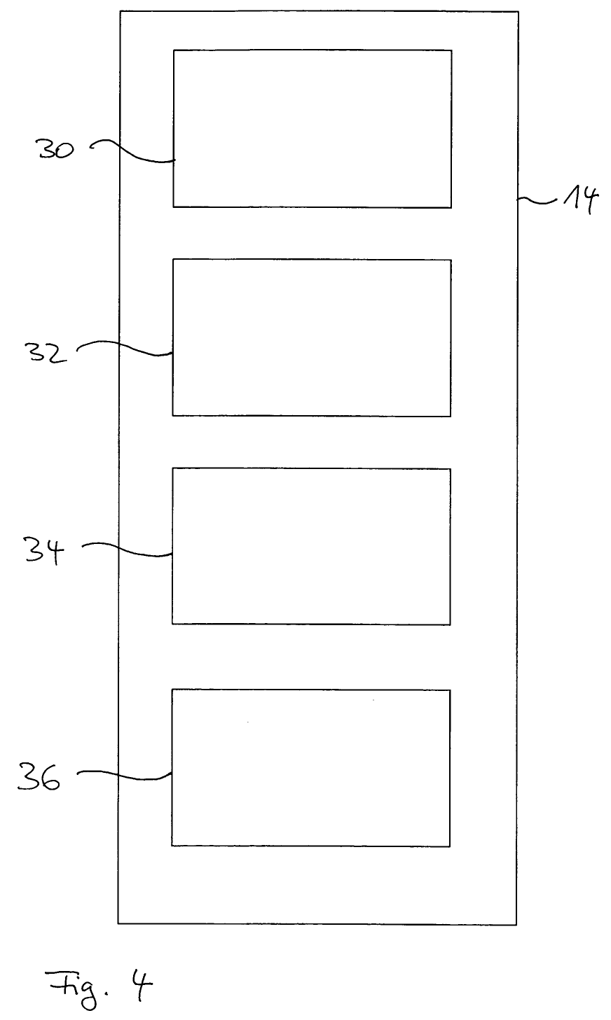

In step B, on the basis of the request received via front-end interface 16, the database server unit 12 may interpret the template structure data that is to be allocated utilizing an interpretation module 30 (cf. FIG. 4). This allows the computer system to recognize the structure of the layout template data that is requested. For example, the template might include styles such as Header 1 to Header 7, index style, style of body text (e.g., style “Body”, font “Arial”, font size “10”, etc.).

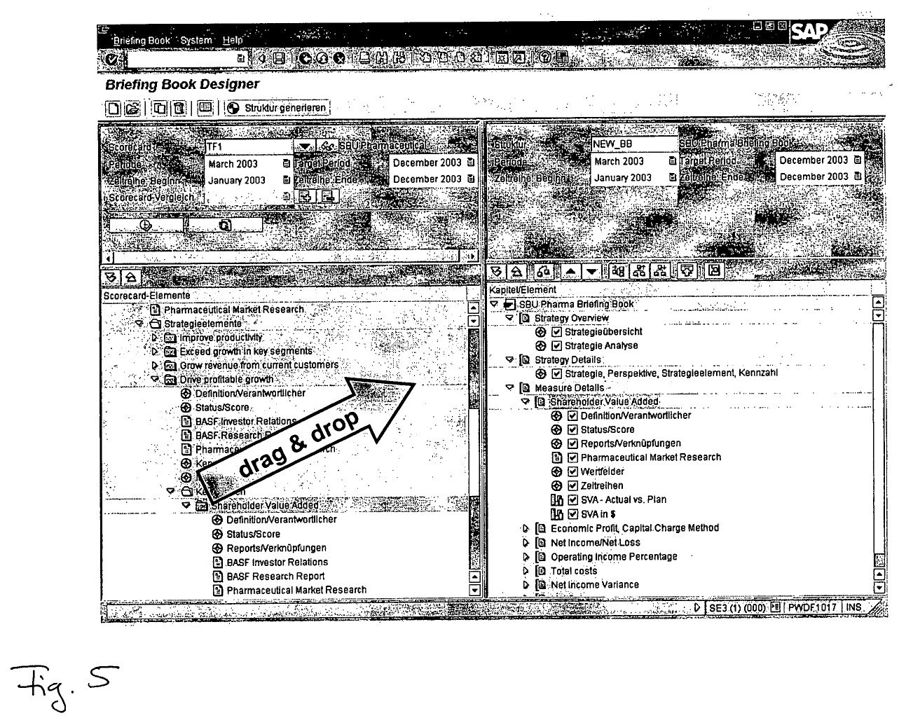

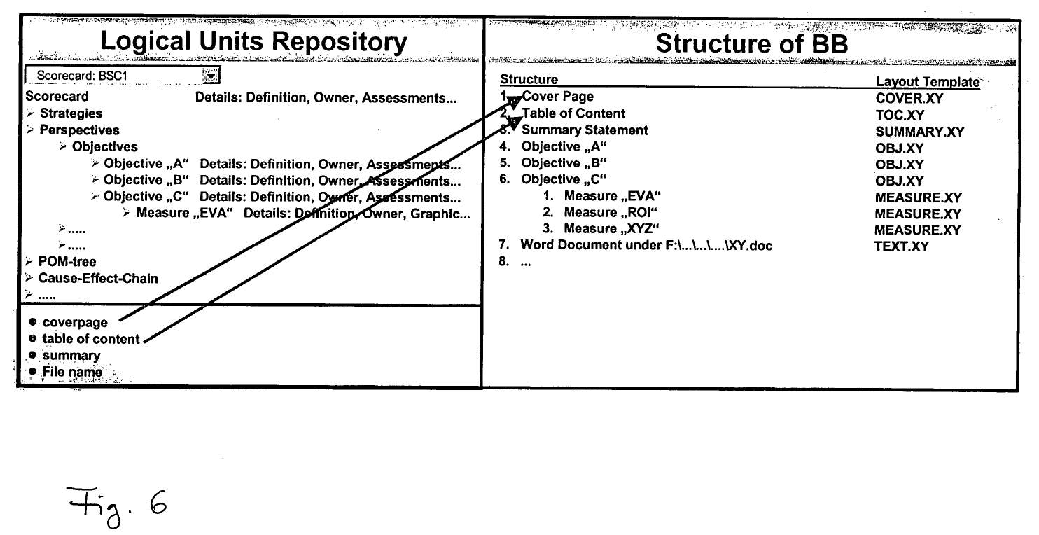

As part of step B, logical units may be selected and assigned into the structure given by the layout. This can be done utilizing a selection module 32 (cf. FIG. 4). Such a selection module may provide user-friendly, drag and drop mechanisms, such as that shown in FIG. 5, where a split screen shows a list of available logical units on the left hand side and the target structure on the right hand side, with the desired logical units being dragged from the left split screen side to the right split screen side where they are dropped. For instance, when a logical unit is dragged to the briefing book structure, all attributes/properties of the logical unit will follow. An example of an excerpt of a structure of the logical unit repository and a briefing book structure behind the split screens of FIG. 5 is shown in FIG. 6. It is to be understood that the briefing book structure is the formal frame of the book to be created and does not yet contain any actual information or data from the balanced score card.

A logical unit in the context of this invention may be defined as the smallest possible data sub-unit of a set of data defining and describing a certain topic, a topic being a project, a machine, a manufacturing line or the like. Or, in other words, a logical unit in the context of this invention may be described as an information “atom”. In the context of a briefing book structure, as described with reference to the figures, a logical unit is a sub-unit of a balanced score card.

When selecting logical units, the user can take advantage of different possibilities, e.g., select one or several single logical units, select for example all measures of a given objective, select and/or unselect details of a selected balanced score card element, select graphical overviews like a strategy map or a prospective overview, and/or add links to Word or Excel files, etc.

In the split screen illustration of FIG. 5, the split screen on the left hand side shows a list of score card elements of a given score card “TF1” for a given period. The split screen on the right hand side is the target screen identifying the structure of the briefing book to be created and showing in the lower area of the right hand split screen the list of chapters and elements selected.

In one embodiment, the logical unit chosen or selected in step B does not contain all the information and data to be inserted in the briefing book, but rather contains a linking structure comprising attributes concerning the target data to be selected from the set of data stored on data base 20. Particularly, the logical unit provides a communication link between the balanced score card (or any other similar software tool) and the data base form which data or data objects can be selected from by containing appropriate attributes or call parameters for the interface to the data base. This allows a user to create a structure first by laying out and storing templates and, subsequently, forwarding the templates to a server structure where logical units are assigned to the layout structure. To facilitate such assignments (including the assignment of layout templates or logical units to book chapters), an assignment module 34 may be provided (cf. FIG. 4). On the basis of the briefing book structure design created that way, a flexible selection of content based on the logical units is possible. Particularly, embodiments of the invention may allow for the retrieval of data from where it is originally stored and subject to changes, amendments or updates so that no additional work is involved when creating an updated book version.

Referring back to FIG. 2, in step C, data is retrieved from the database 20 via interface 21 on the basis of the logical units, and the retrieved data is filled in the briefing book structure, as described above. Then, an extensible markup language file is generated on the basis of the chapter structure containing the retrieved data utilizing a generation module 36 (cf. FIG. 4).

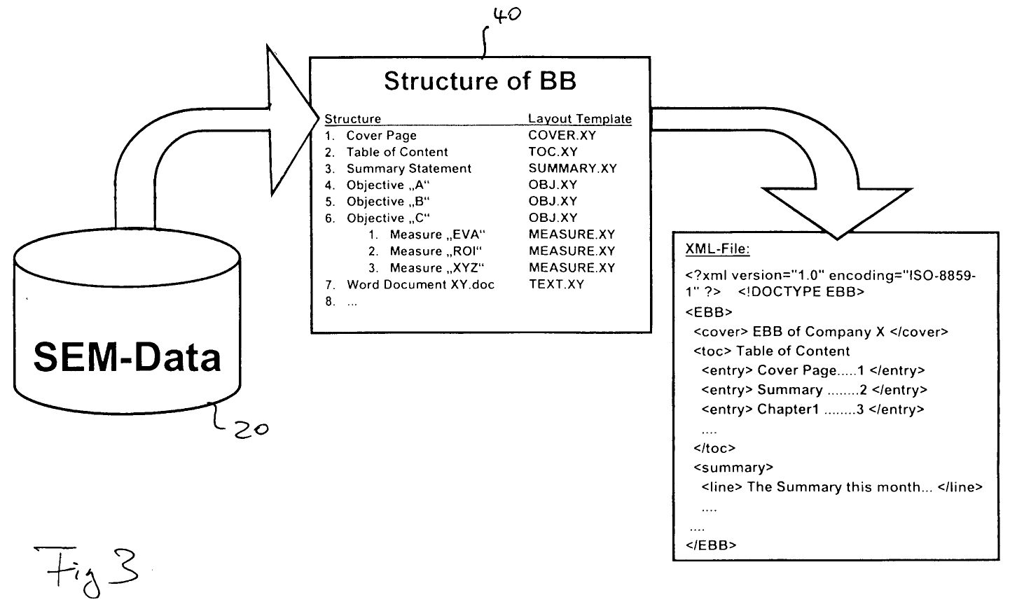

Referring to FIG. 3, an example of step C is visualized wherein case 40 shows a schematic table visualizing the briefing book structure, with the structure defined by logical units on the left hand side and the layout templates forming the basis for the structure on the right hand side. Data is then retrieved from database 20. In a preferred embodiment, database 20 is a strategic enterprise management (SEM) database, SEM being a software solution of the applicant of the present invention containing an integral business data set for strategic enterprise management. However, any other set of data describing an updated situation of a given structure, machine, appliance, manufacturing line, etc. can be used.

Once the structure in case 40 is filled with relevant data from database 20, an XML file is created containing instructions, details, attributes for the layout, the structure, and/or the content of the briefing book to be generated. According to an embodiment of the invention, the creation of an extensible markup language file may allow for improved and uncomplicated use of the disclosed method as the updated briefing book structure can be further handled with any commercially available software tool for final editing and printing. For this, the markup language file may be exported from server unit 12 to front-end computer 18 via interface 16 for final editing and/or printing on the front-end computer 18 (cf. arrow 26 in FIG. 2, step D) with formatting tags contained in the XML file being interpreted and mapped by the software tool used for this step. In one embodiment, the XML is imported from the server side to the front-end side, placeholders are replaced with the actual data, all templates are automatically compiled into one book based on the structure, formatting finish (if necessary) and storing the resulting book structure as print version file.

The placeholders that are defined in a page layout preferably may have options on how to handle various sizes of selected data in case the selected data should not fit into the available place of the placeholder. Several options may be provided for selection by the user, e.g., cut off text that does not fit in the designated text box, allow a flexible size of a text box to display the whole information (with the consequence that subsequent pages might be affected in their layout, reduce/adapt font size automatically, issue a warning to the user.

Finally, referring again to FIG. 2, the print version file obtained as described above may be printed and/or mailed and/or published in step E. It is to be understood that the terms “printing” and “book” in the context of this application relate to both traditional hardcopy printing and modern electronic printing (e.g., by creating so-called PDF files).

Thus, embodiments of the invention provide very useful methods and systems for creating updated book versions by using the logical units concept in order to link a layout structure with a set of data that is available and regularly updated anyway. This concept allows the use of commercially available software tools for the front-end layout and editing work by connecting these commercial tools to the existing database of the user. As a consequence of the interface technology of the invention, a user is now in a position to use his existing data base content in an automated manner to create updated reports, briefing books, manuals and the like.

1. A computer-implemented method, comprising:
creating, on a client front-end computer, a book text structure with layout templates;
receiving, on a database server unit for a database containing a collection of logical units, a request from the client front-end computer for data to be allocated to the layout templates;
selecting required data based on the logical units and assigning layout templates to book chapters;
retrieving the required data and inserting the retrieved data into a book chapter structure;
generating a markup language file on the basis of the chapter structure containing the retrieved data; and
importing, on the client front-end computer, the generated markup language file and converting the same into a print format file.

2. A method according to claim 1, wherein the markup language file is submitted for final editing before being converted into a print format file.

3. A method according to claim 1, wherein the markup language is an extensible markup language.

4. A method according to claim 1, wherein the logical units contain at least one of attributes or call parameters for selecting the data from the database.

5. A method according to claim 1, wherein the data is selected from the database and the database contains an existing updated collection of selectable data.

6. A method according to claim 1, wherein the steps of retrieving and generating are repeated in order to obtain an updated book version on the basis of the created book text structure.

7. A computer system, comprising:
a client front-end computer; and
a database server unit;
the database server unit containing a collection of logical units and a database with a collection of selectable data stored thereon;
the front-end computer comprising a computing tool to create layout templates for various object types, and the database server unit comprising a front-end interface to receive a request from the client front-end computer for data to be allocated to the layout templates;
the database server unit also comprising an interpretation module to interpret template structure data that is requested, a selection module for selecting required data based on the logical units and an assignment module for assigning layout templates to book chapters, whereby the required data is retrieved from the database and inserted in a book chapter structure;
the database server unit further comprising a generation module to generate a markup language file on the basis of the book chapter structure containing the retrieved data, the markup language file being exported via the front-end interface to the client front-end computer, where the markup language file is converted into a print format file.

8. A computer system according to claim 7, wherein the markup language file is submitted for final editing before being converted into a print format file.

9. A computer system according to claim 7, wherein the markup language is an extensible markup language.

10. A computer system according to claim 7, wherein the logical units contain at least one of attributes or call parameters for selecting data from the database.

11. A computer system according to claim 7, wherein the selectable data stored on the database is existing updated data.

12. A computer-readable medium with a computer program stored thereon, the computer program comprising program code for carrying out a method according to claim 1 when the computer program is run on a computer.
